(19) United States
(12) Patent Application Publication
(10) Pub. No.: US 2022/0301449 A1
(43) Pub. Date: Sep. 22, 2022

(54) SYSTEM AND METHOD FOR REMOTE CLASSROOM MANAGEMENT

(71) Applicant: Radix Technologies Ltd., Or Yehuda (IL)

(72) Inventors: Michael SHOHAM, Hemed (IL); Iddo SHOHAM, Beit Rimon (IL)

(73) Assignee: Radix Technologies Ltd., Or Yehuda (IL)

(21) Appl. No.: 17/202,970

(22) Filed: Mar. 16, 2021

(51) Int. Cl. G09B 5/14; G09B 5/10; G09B 5/06

(52) U.S. Cl. CPC G09B 5/14; G09B 5/10; G09B 5/067

(57) ABSTRACT

A system and method for remote classroom management for use with at least one instructor output viewer (IOV), the system including an instructor display generator, operative to generate an instructor display for output on the at least one IOV, the instructor display including a plurality of contiguous student display areas (CSDAs), each of the plurality of CSDAs for displaying output associated with a single student of a corresponding plurality of students, at least two of the plurality of CSDAs including at least one video feed area (VFA), for displaying at least one video feed output associated with the single student, and at least one screen feed area (SFA), for displaying at least one screen share associated with the single student, the VFA and the SFA being visible simultaneously on the at least one IOV.

### SUMMARY OF THE INVENTION

The present invention seeks to provide improved systems for classroom management.

There is thus provided in accordance with a preferred embodiment of the present invention a system for remote classroom management for use with at least one instructor output viewer (IOV), the system including an instructor display generator, operative to generate an instructor display for output on the at least one IOV, the instructor display including a plurality of contiguous student display areas (CSDAs), each of the plurality of CSDAs for displaying output associated with a single student of a corresponding plurality of students, at least two of the plurality of CSDAs including at least one video feed area (VFA), for displaying at least one video feed output associated with the single student, and at least one screen feed area (SFA), for displaying at least one screen share associated with the single student, the VFA and the SFA being visible simultaneously on the at least one IOV.

In a preferred embodiment of the present invention, the at least one screen share includes at least one of a window display associated with the single student, a program display associated with the single student, a display from a single instance of a program associated with the single student and a monitor display associated with the single student. Preferably, a size of the VFA is adjustable and a size of the SFA is adjustable.

In accordance with a preferred embodiment of the present invention, the instructor display is provided to the at least one IOV for display during instruction of at least two of the plurality of students.

Preferably, the instructor display generator is further operative to generate, for display in each of the plurality of CSDAs, a computer-generated indication of at least one of the single student's visual focus and the single student's emotional state.

In a preferred embodiment of the present invention, the instructor display generator is further operative to generate, for display in at least one of the plurality of CSDAs, an indication of at least one of an active program associated with the single student, an active instance of a program associated with the single student, a battery level of a device associated with the single student and a request associated with the single student.

In accordance with a preferred embodiment of the present invention, the instructor display generator is further operative to generate, for display in at least one of the plurality of CSDAs, a visual indication of at least one student group to which the at least one of the plurality of CSDAs belongs.

Preferably, the instructor display further includes an instructional content area (ICA) for displaying instructor-generated material being visible to both an instructor and to at least one student.

In a preferred embodiment of the present invention, the instructor display further includes at least one non-connected student area (NCSA), the NCSA being associated with at least one expected student not connected to the system.

Preferably, the instructor display generator is operative to generate at least one additional instructor display, different from the instructor display, for output on at least one additional IOV.

In accordance with a preferred embodiment of the present invention, the instructor display generator is further operative to generate, for display in at least one of the plurality of CSDAs, at least one of an audio-state indication, an inactive screen share indication, a not connected indication, an active program indication, an active window indication, a battery level indication, a request indication and a locked indication.

There is also provided in accordance with another preferred embodiment of the present invention a method of remote classroom management including generating an instructor display for output on at least one instructor output viewer (IOV), the instructor display including a plurality of contiguous student display areas (CSDAs), each of the plurality of CSDAs for displaying output associated with a single student of a corresponding plurality of students, each of the plurality of CSDAs including at least one video feed area (VFA), for displaying at least one video feed output associated with the single student, and at least one screen feed area (SFA), for displaying at least one screen share associated with the single student, the VFA and the SFA being visible simultaneously on the at least one IOV, and displaying the instructor display on the at least one IOV.

In accordance with a preferred embodiment of the present invention, the instructor display is displayed within a web browser. Alternatively, in accordance with a preferred embodiment of the present invention, the instructor display is displayed within a native application.

Preferably, the generating the instructor display includes relaying information through each of a set of first-tier student devices (FTSDs), the information being relayed between at least one student device of a set of second-tier student devices (STSDs) and at least one instructor computing device operative to display output on the IOV.

In a preferred embodiment of the present invention, the set of STSDs includes a plurality of clusters of the student devices, and each of set of FTSDs is operative to relay information between each of the student devices in at least one of the plurality of clusters of student devices and at least one of the at least one instructor computing device. Preferably, each of the set of FTSDs relays information between a maximum number of the student devices in the set of STSDs.

In accordance with a preferred embodiment of the present invention, the method also includes sending at least one command from an instructor computing device associated with the IOV to at least one device associated with at least one of the single students, the at least one command including at least one of locking the at least one device associated with at least one of the single students, blocking at least one program from being accessed by the at least one device associated with at least one of the single students, blocking at least one webpage from being accessed by the at least one device associated with at least one of the single students, opening a program on the at least one device associated with at least one of the single students, opening a webpage on the at least one device associated with at least one of the single students, modifying contents of a document on the at least one device associated with at least one of the single students, sharing content from the at least one device associated with at least one of the single students with at least one additional device associated with at least one additional student, muting audio input from the at least one device associated with at least one of the single students and unmuting audio input from the at least one device associated with at least one of the single students.

Preferably, the instructor display further includes an instructional content area (ICA), visible to both an instructor and to at least one of the single students, for displaying instructor-generated material, and the method also includes modifying contents of the ICA, the modifying being performed by at least one of the instructor and the at least one of the single students.

In accordance with a preferred embodiment of the present invention, the instructor display is displayed on the at least one IOV during instruction of at least two of the plurality of students.

### BRIEF DESCRIPTION OF THE DRAWINGS

The present invention will be understood and appreciated more fully from the following detailed description, taken in conjunction with the drawings in which:

FIGS. 1A and 1B are, respectively, simplified illustrations of a first and second embodiment of a system for remote classroom management of the present invention; and

FIGS. 2A, 2B, 2C and 2D are, respectively, simplified illustrations of first, second, third and fourth examples of an instructor display forming part of the system of FIGS. 1A & 1B.

### DETAILED DESCRIPTION OF A PREFERRED EMBODIMENT

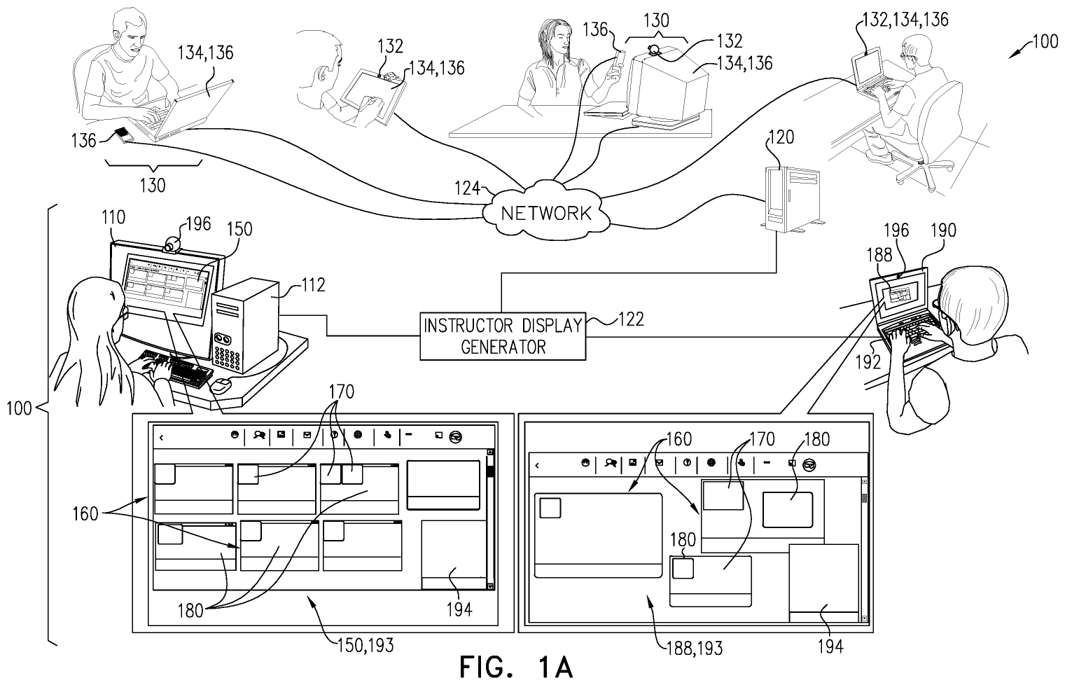

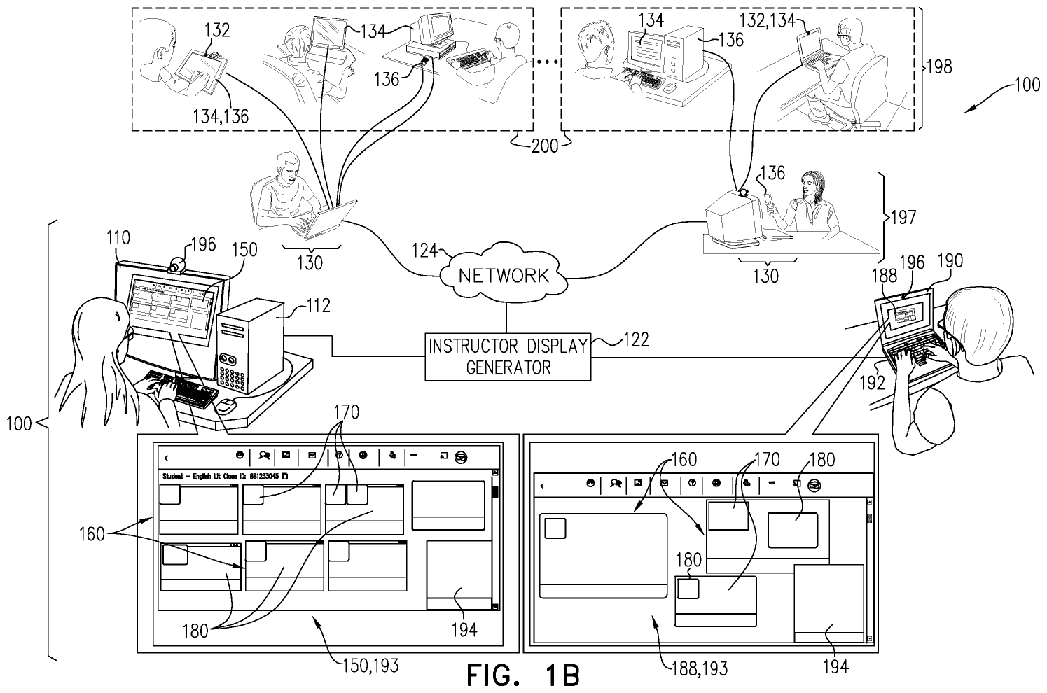

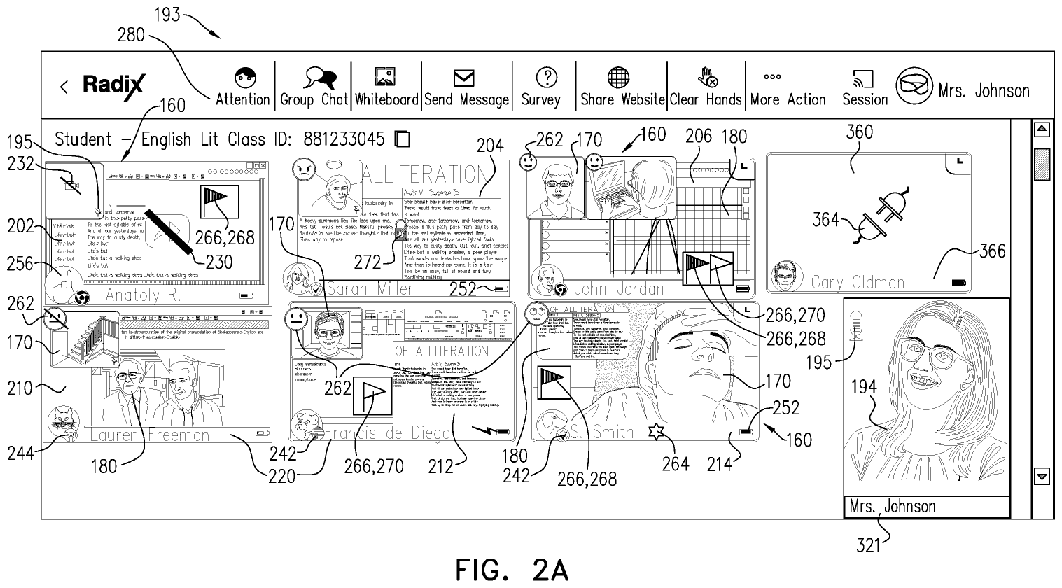

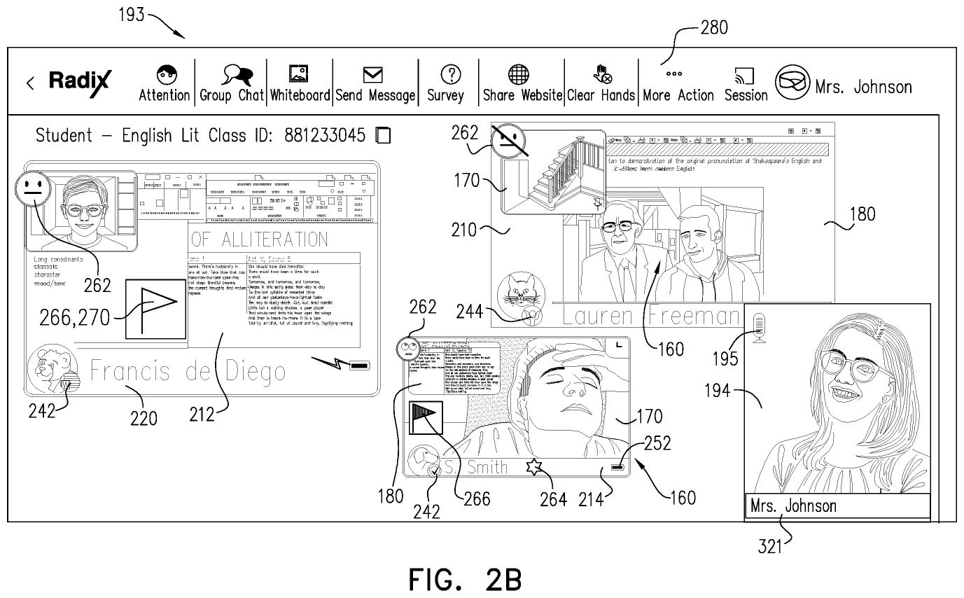

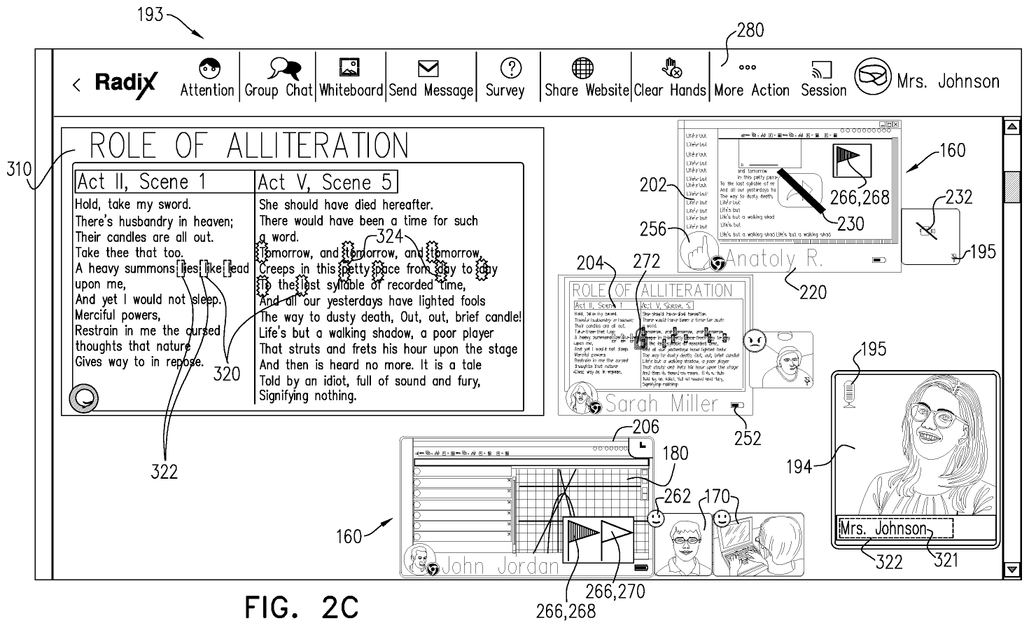

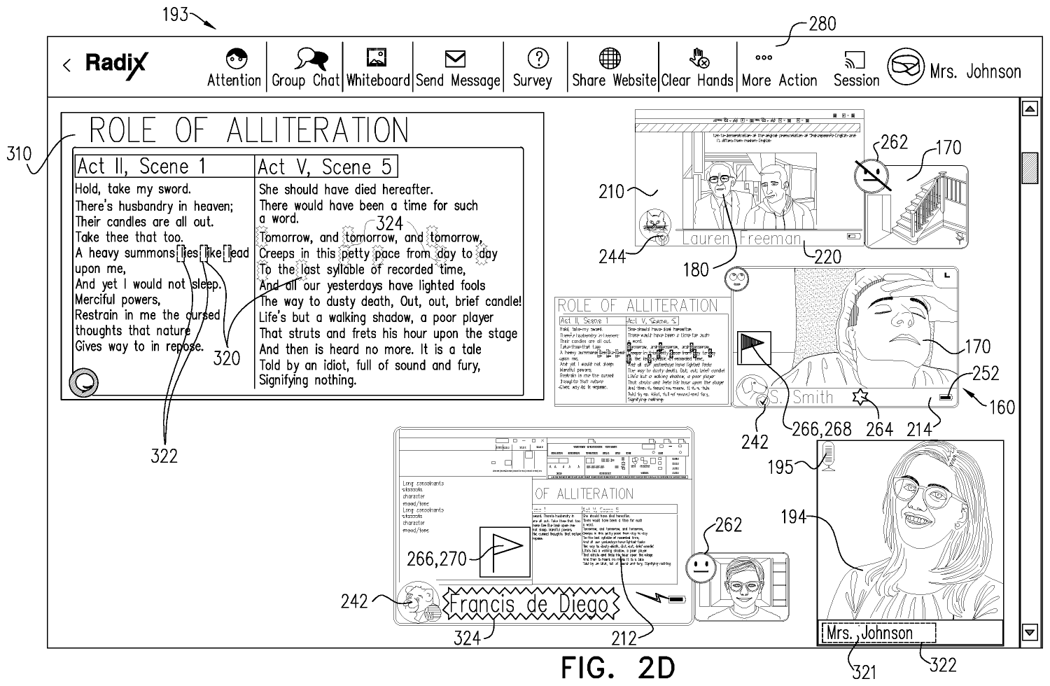

Reference is now made to FIGS. 1A and 1B, are, respectively, simplified illustrations of a first and second embodiment of a system for remote classroom management of the present invention, and to FIGS. 2A-2D, which are, respectively, simplified illustrations of first, second, third and fourth examples of an instructor display forming part the system of FIGS. 1A and 1B.

It is often advantageous in a digital learning environment for an instructor to be able to view, and at least partially control, output viewable on computing devices used by students, particularly during periods of active instruction. Additionally, in a remote digital learning environment, it is often advantageous for an instructor to be able to view video feed displaying students, including students' reactions to instructional material. However, particularly during a period of active instruction, instructors are otherwise occupied with other tasks and cannot easily navigate between displays showing instructional material, output from students' computing devices and students' video feed.

Therefore, as seen particularly in FIGS. 1A and 1B, the present invention seeks to provide an improved system 100, particularly useful in remote classroom management, which enables an instructor to comfortably view, on at least one instructor output viewer (IOV) 110 associated with the instructor, a plurality of contiguous student display areas (CSDAs), each CSDA having both a video feed area (VFA) and a screen feed area (SFA), which are visible simultaneously. Preferably, each IOV 110 is associated with an instructor computing device 112, such as a personal computer or laptop. It is appreciated that one or more IOVs 110 may be associated with a single instructor.

In one embodiment of the present invention, as seen particularly in FIG. 1A, the system preferably includes a server 120 and an instructor display generator 122. It is appreciated that instructor display generator 122 either may be separate from and communicate with server 120 or may be included in server 120. Similarly, server 120 may be included in instructor display generator 122. In one embodiment of the present invention, instructor display generator 122 is included in instructor computing device 112. Server 120 preferably communicates over a network 124, such as the internet or an internal network, with at least one instructor computing device 112, preferably via instructor display generator 122, and a plurality of sets of student devices 130. In another embodiment of the present invention, as seen particularly in FIG. 1B, server 120 is obviated, and peer-to-peer communication is used, in which instructor computing device 112 preferably communicates over network 124 directly with at least one of student devices 130.

Preferably, each set of student devices 130 is associated with a single student and includes at least one student video feed generator (SVFG) 132 and at least one student output viewer (SOV) 134. Typically, each SOV 134 is associated with at least one student computing device 136, and each student computing device 136 may be associated with one or more SOVs 134 and may also be associated with one or more SVFGs 132.

In a preferred embodiment of the present invention, instructor display generator 122 is operative to generate an instructor display 150 for output on at least one IOV 110, where instructor display 150 includes a plurality of contiguous student display areas (CSDAs) 160, at least two of, and more preferably each of, CSDAs 160 for displaying output associated with a single student. Preferably, each of CSDAs 160 receives input for display therein from a single set of student devices 130 of plurality of sets of student devices 130. Preferably, each CSDA 160 includes at least one video feed area (VFA) 170, for displaying at least one video feed output associated with the single student, and at least one screen feed area (SFA) 180, for displaying at least one screen share associated with the single student. It is a particular feature of the present invention that both of VFA 170 and SFA 180 are visible simultaneously in corresponding ones of multiple CSDAs 160, and more particularly, both of the at least one VFA 170 and at least one SFA 180 simultaneously display respective content received for display therein.

Preferably, each VFA 170 displays at least one video feed output generated by the corresponding SVFG 132. It is appreciated that, particularly in an embodiment wherein a student is associated with multiple SVFGs 132, the CSDA 160 associated with that student may include multiple VFAs 170 or a single VFA 170 for displaying multiple video feed outputs received from the multiple SVFGs 132. Similarly, each SFA 180 preferably displays at least one screen share generated by the corresponding SOV 134, and particularly in an embodiment wherein a student is associated with multiple SOVs 134, the CSDA 160 associated with that student may include multiple SFAs 180 or a single SFA 180 displaying multiple screen shares received from the multiple SFAs 180. In a preferred embodiment of the present invention, at least one of VFA 170 and SFA 180 is further operative to receive and display content generated by a student document camera.

In a preferred embodiment of the present invention, instructor display generator 122 is operative to generate at least one additional instructor display 188 for output on at least one additional IOV 190 associated with at least one additional instructor computing device 192, where IOV 110 and additional IOV 190 are associated with different instructors, such as, inter alia, a primary instructor, a teaching assistant and a classroom observer. In this embodiment, server 120 preferably additionally communicates with the at least one additional instructor computing device 192, typically via instructor display generator 122. It is appreciated that instructor display 150 and additional instructor display 188 may be identical displays or may be different displays independently generated by instructor display generator 122.

Preferably, an instructor display 193, which may be embodied as either of instructor displays 150 and 188, further includes an optional instructor video feed area (IVFA) 194, for displaying a video feed generated by at least one instructor video feed generator (IVFG) 196.

In a preferred embodiment of the present invention, system 100 is further operative to allow at least some of the students and instructors to share audio material with one or all participants who are connected to system 100 for an instructional session, including substantially real-time spoken content, such as is typically exchanged as part of a conversation. In such an embodiment, each of CSDAs 160 and IVFA 194 preferably includes an audio-state indication 195 to indicate whether an audio input device, such as a microphone, associated with the corresponding student or instructor is currently muted or unmuted.

It is appreciated that in a preferred embodiment of the present invention, an instructor display 193 is displayed on at least one of IOV 110 or 190, associated with at least one of instructor computing devices 112 or 192, and used during instruction of at least two students by at least one instructor. Additionally, in a preferred embodiment of the present invention, instructor display 193 is displayed and used within a window or tab of a web browser. In an alternative preferred embodiment of the present invention, instructor display 193 is displayed and used within a native application, such as a program intended to be used only or primarily with system 100.

Each of instructor computing devices 112 and 192, as well as each of student computing devices 136, may be any computing device used by an instructor or a student, typically during an instructional period, including, inter alia, a desktop computer, a laptop computer, a tablet and a smart phone. Similarly, each of IOV 110, IOV 190 and SOVs 134 may be any suitable output viewer used by an instructor or a student, respectively, typically during an instructional period, including, inter alia, a computer monitor, a television screen, a tablet screen, a smartphone screen, an image generated by a projector, an augmented reality (AR) display viewer and a virtual reality (VR) display viewer.

Additionally, each of SVFGs 132 and IVFGs 196 may be embodied as any suitable device, such as, inter alia, a webcam, a camcorder and a smartphone camera. It is appreciated that any or all of SVFGs 132 and IVFGs 196 may be part of or separate from corresponding ones of student devices 130, instructor computing device 112 and instructor computing device 192.

In one embodiment of the present invention, server 120 is a physical server, such as a dedicated physical server, and may be located remotely from or on-premises with any or all of instructor computing devices 112 and 192 and student computing devices 136. In another embodiment of the present invention, server 120 may be a virtual server, and may be implemented on the cloud.

Additionally, as seen particularly in FIG. 1B, in another embodiment of the present invention, server 120 may be fully or partially obviated, and be fully or partially replaced by at least one of student devices 130 and instructor computing devices 112 and 192. Thus, for example, content used in generating instructor display 193 may be relayed from a first student device 130 through a second student device 130 before being transmitted to instructor computing device 112 or 192. It is appreciated that in such an embodiment, content used in generating display in instructor display 193 is transmitted peer-to-peer; however, any one of computing devices 112, 130 and 192 preferably only relays information between a maximum number, for example four, five or six, of other computing devices 112, 130 and 192.

This embodiment is particularly useful in limiting bandwidth and computing power required by instructor computing device 112 or 192 while interfacing with system 100. For example, if system 100 includes one instructor computing device 112 and twenty-five student devices 130, the twenty-five student devices 130 may be divided into a set of first-tier student devices (FTSDs) 197 and a set of second-tier student devices (STSDs) 198. Typically, set of STDSs 198 includes a plurality of clusters 200 of student devices 130. While each FTSD 197 preferably communicates with a single cluster 200, a single FTSD 197 may communicate with multiple clusters 200.

Information used in generating instructor display 193 is preferably relayed between each of the student devices 130 which are in set of FTSDs 197 and at least one of instructor computing devices 112 and 192. Additionally, information used in generating instructor display 193 is preferably relayed between an additional set of student devices 130 from STSDs 198 and the student devices 130 of set of FTSDs 197. Typically, each student device in set of FTSDs 197 is operative to relay information between each of student devices 130 in at least one of clusters 200 in STSDs 198 and at least one of instructor computing devices 112 and 192. Thus, although information is transmitted from all student devices 130 to at least one of instructor computing devices 112 and 192, each of instructor computing devices 112 and 192 only communicates directly with the student devices 130 in set of FTSDs 197. Similarly, in such an embodiment, at least one of instructor computing devices 112 and 192 transmits information, such as commands or instructional content, directly to the student devices 130 in set of FTSDs 197, and, if necessary, the information is relayed to the student devices 130 in set of STSDs 198 by the student devices 130 in set of FTSDs 197.

For example, if one instructor computing device 112 and twenty-five student devices 130 are connected to an instructional session of system 100, the set of FTSDs 197 may include five student devices 130 and the set of STSDs 198 may include twenty student devices 130. The twenty student devices 130 in set of STDSs 198 may be divided into five clusters 200 of four student devices 130 each, and each of the clusters 200 may communicate with one of the five student devices 130 in set of FTSDs 197. Thus, information is relayed between instructor computing device 112 and all twenty-five student devices 130 in the instructional session of system 100; however, instructor computing device 112 only communicates directly with five student devices 130. In a similar fashion, as will be clear to persons skilled in the art, student devices 130 may be divided into any suitable number of tiers and clusters, with student devices 130 in each tier relaying information through student devices 130 in another tier until the information reaches instructor computing devices 112 and 192.

Additionally, server 120 may include multiple servers, which may be of a single type of server or of different types of servers, including, inter alia, locally-based on-premises servers and cloud-based servers. Similarly, server or servers 120 may be embodied as Multipoint Conferencing Units (MCUs), Selective Forwarding Units (SFUs) or a combination of MCUs and SFUs. Additionally, at least some of the functions typically performed by server 120 may instead be performed by direct peer-to-peer communication.

In a preferred embodiment of the present invention, multiple servers 120 are available to system 100, and system 100 selects a suitable server 120 or combination of servers 120 based on a suitability for parameters of a particular task or tasks to be performed by system 100. For example, system 100 may be operative to use peer-to-peer communications for embodiments which include relatively few student devices 130 and server-based communications, such as cloud or local communications, for embodiments which include relatively large numbers of student devices 130. Additionally, system 100 may be operative to use a combination of peer-to-peer and server-based communications.

It is appreciated that communication protocols used by system 100 may include, inter alia, Web Real-Time Communication (WebRTC), Hypertext Transfer Protocol (HTTP), Hypertext Transfer Protocol Secure (HTTPS), WebSocket and Real Time Streaming Protocol (RTSP). Similarly, any suitable network or combination of networks may be utilized by system 100, including, inter alia, the World Wide Web and a local network. In an embodiment wherein system 100 utilizes a local network, server 120 may be embodied as a computer program running on a computer that is connected to the local network.

In a preferred embodiment of the present invention, server 120 receives, as multiple data streams from multiple student devices 130, content for display in CSDAs 160 and transmits, in a single data stream, the content for display in CSDAs 160 to each of instructor computing devices 112 and 192. It is appreciated that even in this embodiment, wherein instructor computing devices 112 and 192 receive a single data stream, each CSDA 160 appears in instructor display 193 in a dedicated area, and preferably a user viewing instructor display 193 can readily differentiate each CSDA 160 as being associated with a particular student. In another embodiment of the present invention, one or both of instructor computing devices 112 and 192 receives the content for display in CSDAs 160 as multiple data streams, either directly from student devices 130, from student devices 130 via server 120 or from a combination of server 120 and student devices 130.

In a preferred embodiment of the present invention, a quality, for example a resolution, of each of CDSAs 160, including a quality of each of VFA 170 and SFA 180, may be adjusted, either manually by the instructor or automatically by system 100. It is appreciated that the quality of any of CSDAs 160 may be the same as or different from the quality of other CSDAs 160.

Similarly, the respective displays shown in each of VFAs 170 and SFAs 180 are preferably characterized by a customizable refresh rate. The refresh rate of VFA 170 may be the same as or different from the refresh rate of SFA 180. For example, within instructor display 193, the display shown in each of VFAs 170 and SFAs 180 may be updated, inter alia, 72 times per second, once per 3 seconds or at any other suitable frequency. It is appreciated that the refresh rate of any of CSDAs 160 may be the same as or different from the refresh rate of other CSDAs 160.

In the examples illustrated in FIGS. 2A-2D, CSDAs 160 include CSDA 202, 204, 206, 210, 212 and 214. However, it is appreciated that any suitable number of CSDAs 160 may be included in instructor display 193, such as, inter alia, at least two CSDAs 160, at least five CSDAs 160, at least ten CSDAs 160, at least fifteen CSDAs 160, at least twenty CSDAs 160, at least thirty CSDAs 160, at least forty CSDAs 160, at least fifty CSDAs 160, at least one hundred CSDAs 160, at least two hundred and fifty CSDAs 160 and at least five hundred CSDAs 160. In one embodiment of the present invention, all of CSDAs 160 are visible simultaneously. In another embodiment of the present invention, not all of CSDAs 160 are visible simultaneously; for example, instructor display 193 may extend beyond the display capabilities of the at least one IOV 110 or 190 associated with instructor computing device 112 or 192, and the instructor preferably scrolls within instructor display 193 in order to view different ones of CSDAs 160. As described hereinabove, system 100 preferably enables an instructor to comfortably view CSDAs 160 on one or more IOVs 110 or 190 associated with the instructor.

Preferably, as seen in the examples illustrated in FIGS. 2A-2D, each CSDA 160 includes an identification indication area 220 for displaying therein an identification, such as a name, of the student associated therewith.

In a preferred embodiment of the present invention, each of the screen shares displayed in SFAs 180 of CSDA 160 may include at least one of a window display from SOV 134, as seen particularly in CSDA 204, a program display from SOV 134, as seen particularly in CSDA 210, a display from a single instance of a program from SOV 134, as seen particularly in CSDA 206, and a monitor display from SOV 134, as seen particularly in CSDA 212.

It is noted that as used herein, “window” refers to a typically self-contained visual area containing at least a portion of a graphical user interface of a program. As used herein, a “program display” refers to all, or nearly all, elements displayed by a program running on a computing device. It is appreciated that a single computing device may run a plurality of instances of a program. For example, a single computing device may run a plurality of instances of a word processing program, wherein each instance, such as a window, is used for each of a plurality of documents. Similarly, a single computing device may run multiple instances of an internet browsing program, wherein each instance, such as a tab, is used for each of a plurality of web pages. It is further noted that as used herein, “monitor display” refers to all, or nearly all, elements displayed on at least one screen of a computing device.

Additionally, as used herein, “active” refers to an element with which a user last interfaced or to an element with which a user is currently interfacing. Thus, for example. an active window may refer to the last window with which a user interfaced or to the window with which a user is currently interfacing. As an additional example, an active monitor display may refer to the display of the last monitor with which a user interfaced or to the display of the monitor with which a user is currently interfacing.

If a screen share from a student computing device 136 is not available, the SFA 180 associated with that student computing device 136 preferably displays an inactive screen share indication 230, indicating that a screen share functionality from the student computing device 136 associated with the SFA 180 is not active. Additionally, SFA 180 preferably indicates a reason for the lack of a screen share, such as insufficient bandwidth, and may display the last available screen share from that student computing device 136, as seen in CSDA 202 in the illustrated examples shown in FIGS. 2A and 2C.

Similarly, if a video feed output from SVFG 132 is not available, the VFA 170 associated with that SVFG 132 preferably displays an inactive video feed indication 232 indicating that a video feed function of the SVFG 132 associated therewith is not active, as seen in CSDA 202 in the illustrated examples shown in FIGS. 2A and 2C. Additionally, VFA 170 may indicate a reason for the lack of a video feed output, such as insufficient bandwidth, and may display the last available video feed output from that SVFG 132.

CSDA 160 preferably further displays a program indication 242 of an active program on student computing device 136 associated therewith, as seen particularly in CSDAs 212 and 214, or a window indication 244 of an active window on student computing device 136 associated therewith, as seen particularly in CSDA 210. For example, if a student computing device 136 is running a word processing program, an internet browser and a program associated with system 100, program indication 242 provides an indication of which of the word processing program, the internet browser and the program associated with system 100 is currently active, such as the internet browser. Similarly, if a student computing device 136 is running multiple sessions of an internet browser, such as a session with an email service, a session with an online encyclopedia and a session with a weather forecast, window indication 244 provides an indication of which of the sessions is currently active, such as the session with the online encyclopedia.

Additionally, CSDA 160 preferably displays a battery level indication 252, indicating a battery level of at least one of student devices 130, for example, charging, fully charged, partially depleted or almost completely depleted. In one embodiment of the present invention, instructor display generator 122 generates a warning associated with the CSDA 160, such as a visual warning, for display in the CSDA 160 on instructor display 193, or an audio warning, preferably output via instructor device 112 or 192, to the instructor if the battery level of one or more student devices 130 associated therewith falls below a predetermined threshold.

In a preferred embodiment of the present invention, in response to a student request input, instructor display generator 122 may generate for display in at least one CSDA 160, a request indication 256, indicating a student request. For example, request indication 256 may inform the instructor that the student associated with the CSDA 160 has requested to, inter alia, respond to a question posed by the instructor, speak with the instructor, message the instructor, receive from the instructor permission to take a break or receive from the instructor permission for non-standard use of a computing device. In one embodiment of the present invention, a single appearance of request indication 256 is used for all student requests. In another embodiment of the present invention, an appearance of request indication 256 may vary depending on a type of student request.

Instructor display generator 122 may also preferably generate, for display in CSDA 160, a computer-generated state indication 262, indicating a visual focus and/or an emotional state of the student associated therewith. Preferably, computer-generated state indication 262 is at least partially based on an appearance of the student visible in VFA 170.

For example, CSDAs 204, 206 and 212 each show an example of computer-generated state indication 262, based on facial expressions visible in respective VFAs 170 thereof, of an emotional state of the respective student associated therewith.

Similarly, CSDA 214 shows an example of computer-generated state indication 262, based on eye position visible in the corresponding VFAs 170, of a visual focus of the student associated therewith. In the illustrated example, since the eyes of the student visible in VFA 170 of CSDA 214 are closed, computer-generated state indication 262 of CSDA 214 indicates that the student is not paying attention. In a preferred embodiment of the present invention, if the eyes of the student visible in VFA 170 of CSDA 214 either are closed or are open but are not directed toward the student's computing device, computer-generated state indication 262 of CSDA 214 indicates that the student is not paying attention.

Additionally, as seen in CSDA 210, if no student is visible in the corresponding VFA 170, CSDA 210 preferably displays computer-generated state indication 262, based on video content in the corresponding VFA 170, indicating that no student is visible therein.

In a preferred embodiment of the present invention, particular ones of computer-generated state indications 262 are associated with a warning, such as a visual warning or an audio warning. For example, a computer-generated state indication 262 that a student is not paying attention may be associated with a visual warning 264, such as star, displayed in the corresponding CSDA 160, as seen particularly in FIGS. 2A, 2B and 2D. Alternatively, visual warning 264 may be embodied as a colored frame around the corresponding CSDA 160. Similarly, a computer-generated state indication 262 of an emotional state indicating that a student is crying may be associated with an auditory warning, such as a sound played by instructor computing device 112 or 192.

Instructor display generator 122 may also preferably generate, for display in CSDA 160, a group indication 266, such as a visual indication, of at least one student group to which CSDA 160 belongs. For example, group indication 266 may be embodied as a textured flag displayed in CSDA 160, as seen particularly in FIGS. 2A-2D. Alternatively, group indication 266 may be embodied as a colored frame around CSDA 160. It is appreciated that there may be any suitable number of groups, and that students may belong to no groups, to a single group, or to multiple groups. In the illustrated example, students associated with CSDAs 202, 206 and 214 belong to a first student group, as indicated by a first-group indication 268, while students associated with CSDAs 206 and 212 belong to a second student group, as indicated by a second-group indication 270.

Preferably, each of student devices 130, when connected to system 100, is operative to receive commands remotely from at least one of instructor computing devices 112 and 192. For example, an instructor may use instructor computing device 112 or 192 to lock at least one student computing device 136, as indicated by a locked indication 272 in CSDA 204, thereby preventing that student computing device 136 from responding to commands from anyone other than the instructor. Similarly, in a preferred embodiment of the present invention, the instructor may use instructor computing device 112 or 192 to block certain programs or websites from being accessed by one or more student computing devices 136, particularly while the student computing device or devices 136 are connected to system 100.

Additionally, system 100 preferably allows the instructor to use instructor computing device 112 or 192 to remotely control at least one student computing device 136 by issuing remote commands thereto, thereby, for example, opening a particular program or webpage on the student computer, modifying the contents of a document on the student computer or performing other tasks using the student computer. Similarly, the instructor preferably may use system 100 to share content from at least one student device 130, which is preferably associated with at least a first student, with at least one additional student device 130, which is preferably associated with at least one additional student. Additionally, system 100 preferably allows the instructor to mute or unmute student audio input, for example by muting or unmuting the audio input device associated with one or more students. It is appreciated that such remote commands may be used by the instructor, inter alia, to provide technical assistance or educational assistance to at least one student. In a preferred embodiment of the present invention, instructor display 193 includes a toolbar 280, which may be used to issue at least some of the remote commands.

It is noted that the instructor may preferably use instructor computing device 112 or 192 to issue the remote commands to one or more individual student devices 130, to all student devices 130 in one or more student groups, to any combination thereof or to all student devices 130 connected to system 100. It is further noted that as used herein, “remote commands” refers to commands issued to one computing devices from a different computing device, regardless of a physical location of the computing devices.

It is a particular feature of the present invention that a size of at least one of, and preferably of both of, VFA 170 and SFA 180, is adjustable, and that preferably the instructor can control the respective sizes of VFA 170 and SFA 180. Preferably, VFA 170 is characterized by a first size and SFA 180 is characterized by a second size. In one embodiment of the present invention, the respective sizes VFA 170 and SFA 180 are different sizes. In another embodiment of the present invention, the respective sizes VFA 170 and SFA 180 are the same size.

Preferably, the respective sizes of VFA 170 and SFA 180 are operative to be adjusted either automatically, as by instructor display generator 122, or manually, as by the instructor. Additionally, in a preferred embodiment of the present invention, the respective sizes of VFA 170 and SFA 180 may be adjusted either independently of one another or together with one another. For example, an instructor may, inter alia, adjust the size of VFA 170 without changing a size of corresponding SFA 180, adjust the size of VFA 170 by a fixed scaling factor of the adjustment applied to SFA 180. In one typical embodiment, if the instructor clicks on one of VFA 170 and SFA 180, then the sizes of VFA 170 and SFA 180 reverse. Thus, if, for example, the size of VFA 170 is 4 cm² and the size of SFA 180 is 20 cm², the instructor may preferably click on either of VFA 170 and SFA 180 in order to adjust their respective sizes, so that the size of VFA 170 becomes 20 cm² and the size of SFA 180 becomes 4 cm².

As seen particularly in FIGS. 2A and 2C, sizes of different ones of CSDAs 160 may be the same as one another. Alternatively, as seen particularly in FIGS. 2B and 2D, the sizes of different ones of CSDAs 160 may differ from one another. Similarly, the sizes of different ones of VFAs 170 may be the same as one another or may differ from one another. Additionally, the sizes of different ones of SFAs 180 may be the same as one another or may differ from one another.

Additionally, as seen particularly in FIGS. 2B and 2D, in a preferred embodiment of the present invention, a position of each of CSDAs 160 within instructor display 193 may be adjusted. Furthermore, in a preferred embodiment of the present invention, a position of each of VFA 170 and SFA 180 within CSDA 160 may be adjusted. It is appreciated that the respective positions of VFA 170 and SFA 180 may be selected such that VFA 170 and SFA 180 at least partially overlap one another, as seen particularly in FIGS. 2A and 2B. Alternatively, the respective positions of VFA 170 and SFA 180 may be selected such that VFA 170 and SFA 180 do not overlap one another, as seen particularly in FIGS. 2C and 2D.

As seen particularly in FIGS. 2C and 2D, instructor display 193 preferably further includes an instructional content area (ICA) 310, which is visible to both the instructor and to at least one student, for displaying instructor-generated material, such as at least one of an instructor screen share, a digital whiteboard and a display from a document camera. Preferably, the instructor screen share may include at least one of a window display from the instructor computing device, a program display from the instructor computing device, a display from a single instance of a program from the instructor computing device and a monitor display from the instructor computing device. In a preferred embodiment of the present invention, at least one of a position and a size of ICA 310, as displayed on instructor display 193, may be adjusted by the instructor.

Preferably, instructor display generator 122 is operative to modify contents of ICA 310, for example by displaying annotations added by the instructor, by at least one student or by both the instructor and at least one student. Additionally, instructor display generator 122 preferably displays on instructor display 193, an indication associating each of a plurality of modifications 320 made to ICA 310 with the user who made that modification, typically by modifying a portion of the CSDA 160 associated with the student or teacher who made the modification. For example, instructor display generator 122 may modify an appearance of the identification indication area 220 of the CSDA 160 associated with the student who made the modification, so the appearance of identification area 220 corresponds to an appearance of the modification. Similarly, if a teacher made the modification, instructor display generator 122 may modify an appearance of a teacher identification area 321 of IVFA 194 to correspond to an appearance of the modification.

For example, in the embodiment of the present invention shown in FIGS. 2C and 2D, modifications 320 made by a first user may be displayed in a first style 322, such as color, a texture, a line thickness or another suitable characteristic, and, in instructor display 193, first style 322 is also displayed on the CSDA 160 or IVFA 194 of the corresponding user who made modification 320, which in the illustrated embodiments of FIGS. 2C and 2D is IVFA 194. Similarly, modifications 320 made by a second user may be displayed in a second style 324, such as color, a texture, a line thickness or another suitable characteristic, and, in instructor display 193, second style 324 is also displayed on the CSDA 160 or IVFA 194 of the corresponding user who made that modifications 320, which in the illustrated embodiment of FIG. 2D is CSDA 212.

In another embodiment of the present invention, instructor display 193 preferably associates modifications made to ICA 310 with a category of user who made the modification, for example, “student” or “instructor.”

Additionally, contents of instructor display 193 may preferably be recorded and saved for future access.

In a preferred embodiment of the present invention, instructor display generator 122 has access to a list of expected students for the instructional session. The list of expected students may be provided by any suitable process, for example, manual entry by an instructor or automated data retrieval from a registration system.

If at least one of the expected students is absent, i.e., at least one of the expected students is not associated with any of student devices 130 which are connected to system 100 for the instructional session, instructor display 193 preferably includes at least one non-connected student area (NCSA) 360 associated with at least one of the absent expected students. In one embodiment of the present invention, instructor display 193 includes a separate NCSA 360 for each absent expected student. In another embodiment of the present invention, a single NCSA 360 may indicate a multiplicity of absent expected students. Preferably, NCSA 360 includes a not connected indication 364, as well as an identification indication area 366 for displaying therein an identification, such as a name, of the absent expected student or students associated therewith. It is appreciated that “absent expected student” refers to a user who is expected to join an instructional session of system 100, but who is not connected to system 100.

It is appreciated that while in the illustrated embodiments of FIGS. 1A-2D, elements of instructor display 193 are shown as having particular shapes; for example, each of CSDA 160, VFA 170, SFA 180 and ICA 310 are shown as being generally rectangular, and each of indications 242 and 262 are shown as being generally circular, preferably elements of instructor display 193 may be characterized by any suitable shape. Additionally, any suitable representation may be used for the elements disclosed herein, and the present invention is not limited to the graphic icons chosen as illustrative examples in FIGS. 1A-2D.

It is appreciated that, while in the illustrated embodiments shown in FIGS. 1A-2D each instructor display 193 is associated with a single IOV 110, a single instructor display 193 may be split among multiple IOVs 110 associated with a single instructor.

More generally, it will be appreciated by persons skilled in the art that the present invention is not limited to what has been particularly shown and described hereinabove. Rather the present invention includes combinations and sub-combinations of various features described hereinabove as well as modifications and variations thereof which are not in the prior art.

1. A system for remote classroom management for use with at least one instructor output viewer (IOV), the system comprising:
an instructor display generator, operative to generate an instructor display for output on said at least one IOV, said instructor display comprising a plurality of contiguous student display areas (CSDAs), each of said plurality of CSDAs for displaying output associated with a single student of a corresponding plurality of students, at least two of said plurality of CSDAs comprising:
at least one video feed area (VFA), for displaying at least one video feed output associated with said single student; and
at least one screen feed area (SFA), for displaying at least one screen share associated with said single student;
said VFA and said SFA being visible simultaneously on said at least one IOV.

2. A system according to claim 1 and wherein said at least one screen share comprises at least one of:
a window display associated with said single student;
a program display associated with said single student;
a display from a single instance of a program associated with said single student; and
a monitor display associated with said single student.

3. A system according to claim 1 and wherein:
a size of said VFA is adjustable; and
a size of said SFA is adjustable.

4. A system according to claim 1 and wherein said instructor display is provided to said at least one IOV for display during instruction of at least two of said plurality of students.

5. A system according to claim 1 and wherein said instructor display generator is further operative to generate, for display in each of said plurality of CSDAs, a computer-generated indication of at least one of:
said single student's visual focus; and
said single student's emotional state.

6. A system according to claim 1 and wherein said instructor display generator is further operative to generate, for display in at least one of said plurality of CSDAs, an indication of at least one of:
an active program associated with said single student;
an active instance of a program associated with said single student;
a battery level of a device associated with said single student; and
a request associated with said single student.

7. A system according to claim 1 and wherein said instructor display generator is further operative to generate, for display in at least one of said plurality of CSDAs, a visual indication of at least one student group to which said at least one of said plurality of CSDAs belongs.

8. A system according to claim 1 and wherein said instructor display further comprises an instructional content area (ICA) for displaying instructor-generated material being visible to both an instructor and to at least one student.

9. A system according to claim 1 and wherein said instructor display further comprises at least one non-connected student area (NCSA), said NCSA being associated with at least one expected student not connected to said system.

10. A system according to claim 1 and wherein said instructor display generator is operative to generate at least one additional instructor display, different from said instructor display, for output on at least one additional IOV.

11. A system according to claim 1 and wherein said instructor display generator is further operative to generate, for display in at least one of said plurality of CSDAs, at least one of:
an audio-state indication;
an inactive screen share indication;
a not connected indication;
an active program indication;
an active window indication;
a battery level indication;
a request indication; and
a locked indication.

12. A method of remote classroom management comprising:
generating an instructor display for output on at least one instructor output viewer (IOV), said instructor display comprising a plurality of contiguous student display areas (CSDAs), each of said plurality of CSDAs for displaying output associated with a single student of a corresponding plurality of students, each of said plurality of CSDAs comprising:
at least one video feed area (VFA), for displaying at least one video feed output associated with said single student; and
at least one screen feed area (SFA), for displaying at least one screen share associated with said single student;
said VFA and said SFA being visible simultaneously on said at least one IOV; and
displaying said instructor display on said at least one IOV.

13. A method according to claim 12 and wherein said instructor display is displayed within a web browser.

14. A method according to claim 12 and wherein said instructor display is displayed within a native application.

15. A method according to claim 12 and wherein said generating said instructor display comprises relaying information through each of a set of first-tier student devices (FTSDs), said information being relayed between:
at least one student device of a set of second-tier student devices (STSDs); and
at least one instructor computing device operative to display output on said IOV.

16. A method according to claim 15 and wherein:
said set of STSDs comprises a plurality of clusters of said student devices; and
each of set of FTSDs is operative to relay information between:
each of said student devices in at least one of said plurality of clusters of student devices; and
at least one of said at least one instructor computing device.

17. A method according to claim 15 and wherein each of said set of FTSDs relays information between a maximum number of said student devices in said set of STSDs.

18. A method according to claim 12 and also comprising sending at least one command from an instructor computing device associated with said IOV to at least one device associated with at least one of said single students, said at least one command comprising at least one of:
locking said at least one device associated with at least one of said single students;
blocking at least one program from being accessed by said at least one device associated with at least one of said single students;
blocking at least one webpage from being accessed by said at least one device associated with at least one of said single students;
opening a program on said at least one device associated with at least one of said single students;
opening a webpage on said at least one device associated with at least one of said single students;
modifying contents of a document on said at least one device associated with at least one of said single students;
sharing content from said at least one device associated with at least one of said single students with at least one additional device associated with at least one additional student;
muting audio input from said at least one device associated with at least one of said single students; and
unmuting audio input from said at least one device associated with at least one of said single students.

19. A method according to claim 12 and wherein said instructor display further comprises an instructional content area (ICA), visible to both an instructor and to at least one of said single students, for displaying instructor-generated material, said method also comprising modifying contents of said ICA, said modifying being performed by at least one of:
said instructor; and
said at least one of said single students.

20. A method according to claim 12 and wherein said instructor display is displayed on said at least one IOV during instruction of at least two of said plurality of students.
